(19) United States
(12) Patent Application Publication
(10) Pub. No.: US 2019/0126795 A1
(43) Pub. Date: May 2, 2019

(54) ARM SUPPORT SYSTEMS

(71) Applicant: ENHANCE TECHNOLOGIES, LLC, San Diego, CA (US)

(72) Inventor: Mark C. Doyle, Del Mar, CA (US)

(21) Appl. No.: 16/177,003

(22) Filed: Oct. 31, 2018

Related U.S. Application Data
(63) Continuation-in-part of application No. PCT/US2017/030918, filed on May 3, 2017.
(60) Provisional application No. 62/331,395, filed on May 3, 2016.

(51) Int. Cl. B60N 2/75; A47C 7/54; B60N 2/24

(52) U.S. Cl. CPC B60N 2/767; B60N 2/753; B60N 2/24; A47C 7/541; A47C 7/543

(57) ABSTRACT

Systems and methods are provided for supporting an arm of a user using an arm support coupled to a mounting structure, e.g., mounted to a seat, such as an automobile seat within a vehicle. The arm support is configured to accommodate movement of the arm while following the movement without substantially interfering with the movement of the user's arm. One or more compensation elements may be coupled to the arm support to apply an offset force to at least partially offset a gravitational force acting on the arm as the user moves and the arm support follows the movement of the user's arm, the one or more compensation elements providing a force profile that varies the offset force based on an orientation of the arm support.

### RELATED APPLICATION DATA

The present application is a continuation-in-part of co-pending International Application No. PCT/US2017/030918, filed May 3, 2017, which claims benefit of provisional application Ser. No. 62/331,395, filed May 3, 2016, the entire disclosures of which are expressly incorporated by reference herein.

### FIELD OF THE INVENTION

The present invention relates to systems, devices, and methods for supporting a user's arms, for example, to adaptive arm support systems that support one or both of a user's arms, while allowing substantially free motion, e.g., to allow the user to perform one or more tasks for extended periods of time with one or both arms extended.

### BACKGROUND

Numerous tasks require people to work with their arms outstretched, e.g., while operating hand tools or other equipment that they must at least partially support themselves. Examples include construction, surgery, dentistry, painting, dishwashing, and product assembly. Persons engaged in such activities may experience fatigue from prolonged muscular efforts required to resist the force of gravity on their arms in order to keep them extended. Weak or disabled persons may experience fatigue performing daily tasks. Static arm rests on chairs and work tables are only effective if the task is performed within a relatively restricted area, for example, at a computer keyboard. Tasks that involve a greater range of motion are not aided by static armrests.

Thus, there is a need for systems that may relieve fatigue experienced by persons performing tasks involving moderate to large ranges of motion and/or operating tools or other equipment.

### SUMMARY

The present invention is directed to systems, devices, and methods for supporting a user's arms, for example, to adaptive arm support systems or devices that support one or both of a user's arms, while allowing substantially free motion, e.g., to allow the user to perform one or more tasks for extended periods of time with one or both arms extended.

In an exemplary embodiment, an adaptive arm support system is provided that counterbalances at least a portion of the weight of a user's arm and is mounted on an external structure instead of the user's torso, e.g., to a seat, such as an automobile seat within a vehicle. Exemplary arm support components that may be included in the embodiments herein, such as modules or other compensation elements, arm rest features, covers, and the like, are described in U.S. Publication Nos. 2012/0184880, 2014/0033391, 2014/0158839, and 2015/0316204, the entire disclosures of which are expressly incorporated by reference herein.

In accordance with one embodiment, a system is provided for supporting an arm of a user while seated that includes a seat including a base and a seat back, a seat bracket comprising a first end mounted to the seat back and a second end; an arm support coupled to the second end of the seat bracket configured to support an arm of the user, the arm support configured to accommodate movement of the arm while following the movement without substantially interfering with the movement of the user's arm; and one or more compensation elements coupled to the arm support to apply an offset force to at least partially offset a gravitational force acting on the arm as the user moves and the arm support follows the movement of the user's arm. In an exemplary embodiment, at least a portion of the arm support is detachable from the seat bracket and/or the seat bracket is retractable to allow an occupant to sit in the seat without using the arm support.

In accordance with another embodiment, a system is provided for support an arm of a user while seated within a vehicle that includes a seat including a base and a seat back within the vehicle; a seat bracket comprising a first end mounted to the vehicle adjacent the seat back and a second end; an arm support coupled to the second end of the seat bracket configured to support an arm of the user, the arm support configured to accommodate movement of the arm while following the movement without substantially interfering with the movement of the user's arm; and one or more compensation elements coupled to the arm support to apply an offset force to at least partially offset a gravitational force acting on the arm as the user moves and the arm support follows the movement of the user's arm.

In accordance with still another embodiment, a system is provided for supporting an arm of a user that includes a mounting structure; an arm support coupled to the mounting structure configured to support an arm of the user, the arm support configured to accommodate movement of the arm while following the movement without substantially interfering with the movement of the user's arm; and one or more compensation elements coupled to the arm support to apply an offset force to at least partially offset a gravitational force acting on the arm as the user moves and the arm support follows the movement of the user's arm, the one or more compensation elements providing a force profile that varies the offset force based on an orientation of the arm support.

In accordance with yet another embodiment, a method is provided for supporting an arm of a user when seated within a vehicle, the vehicle including an arm support mounted within the vehicle adjacent a seat. The method may include sitting in the seat; placing an arm in an arm rest of the arm support; and performing one or more tasks involving movement of the arm, the one or more compensation elements applying an offset force to at least partially offset a gravitational force acting on the arm as the user moves without substantially interfering in the movement.

Other aspects and features of the present invention will become apparent from consideration of the following description taken in conjunction with the accompanying drawings.

### BRIEF DESCRIPTION OF THE DRAWINGS

The present invention is best understood from the following detailed description when read in conjunction with the accompanying drawings. It will be appreciated that the exemplary devices shown in the drawings are not necessarily drawn to scale, with emphasis instead being placed on illustrating the various aspects and features of the illustrated embodiments.

FIG. 1A is a perspective view of an exemplary embodiment of an arm support system mounted to an external structure.

FIG. 1B is a side view of the arm support system of FIG. 1A showing an arm support for a user's right arm in raised and lowered positions.

FIGS. 2A and 2B are perspective front and back views, respectively, of an arm support system mounted to an automobile seat.

### DESCRIPTION OF THE EXEMPLARY EMBODIMENTS

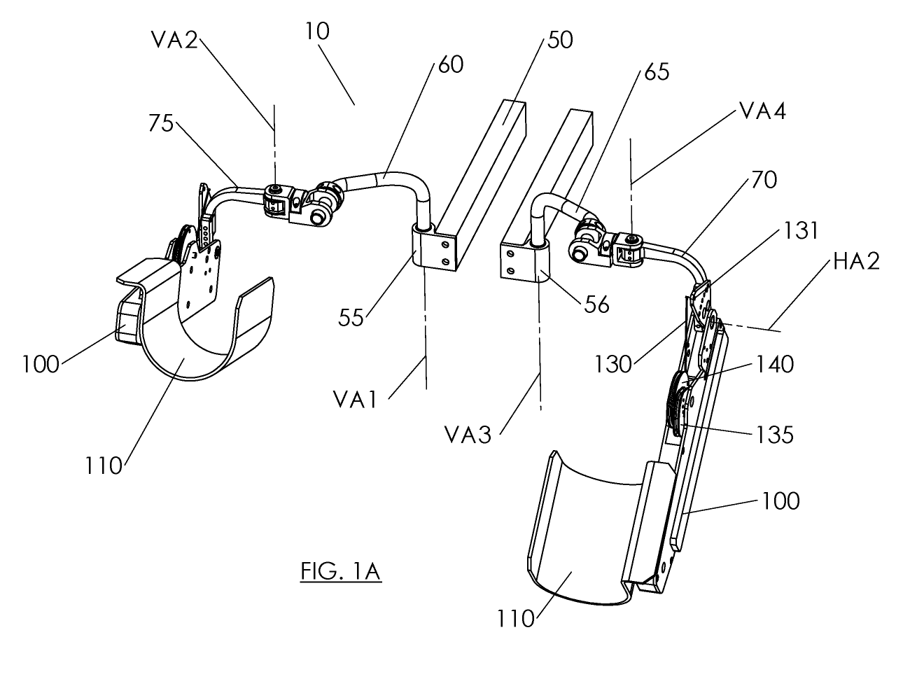

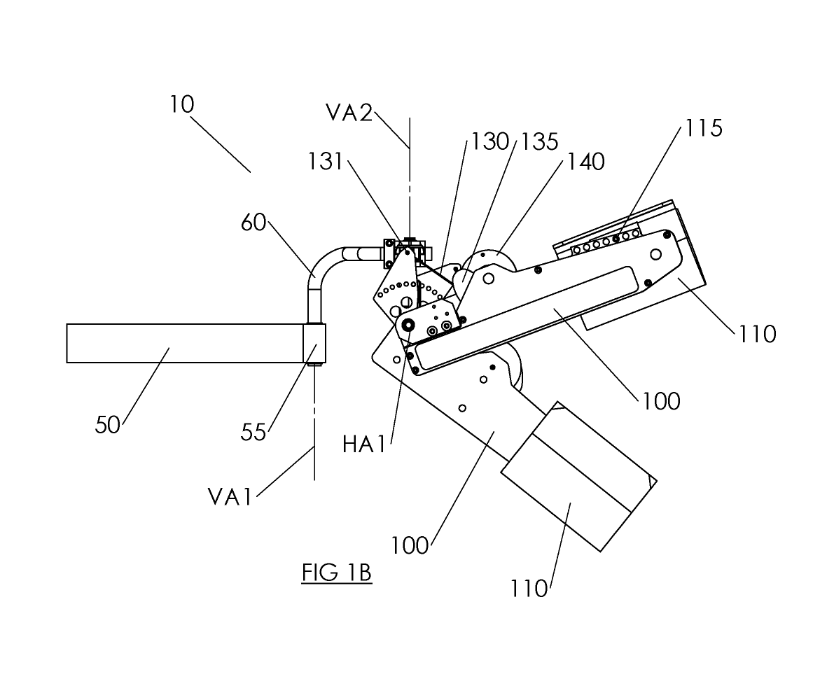

Turning to the drawings, FIGS. 1A and 1B show a first exemplary embodiment of an adaptive arm support system 10 mounted to an external structure 50, such as a wall, bracket, table, machine, vehicle, or chair (not shown). One or more detachable arm support modules 100 (e.g., one for each arm) may be provided that carry an armrest 110 sized and/or shaped to receive and/or support a portion of the user's arm (not shown). The modules 100 may pivot about horizontal axes HA1 and HA2, e.g., to accommodate the user raising and lowering their arms during use. As previously disclosed in the applications incorporated by reference herein, the modules 100 may include one or more compensation elements, e.g., one or more springs, cables, and/or pulleys, that provide a counterbalancing force on the user's arm, to offset at least a portion of the weight of the user's arm. In an exemplary embodiment, each module 100 may include an elongate frame or bracket including a first end mounted to shoulder brackets 70 and 75 and second free ends adjacent the arm rests 100 at which the module 100 terminates. The frame may carry the components of the compensation element(s) and, optionally, a cover (not shown) to prevent exposure of the user to the compensation element(s).

Each shoulder bracket 70, 75 is a rigid bar, bracket, or other member, e.g., having a curved “L” shape, that includes a first end coupled to support brackets 60, 65, e.g., such that the shoulder brackets 70, 75 may pivot about vertical axes VA2 and VA4, and a second end coupled to the respective module 100, e.g., to the first end of the frame.

Each support bracket 60, 65 may be a rigid or semi-rigid tube, bar, or other structure including a first end for mounting the support bracket 60, 65 to an external structure 50, and a second end pivotally coupled to the corresponding shoulder bracket 70, 75. Optionally, the support brackets 60, 65 may be rotatable about vertical axes VA1 and VA3, for additional mobility, range, or for storage of the adaptive arm support system 10. Alternatively, the support brackets 60, 65 may be fixed such that the second end of the support bracket 60, 65 is fixed relative to the external structure 50. Thus, in this alternative, the first end of the shoulder brackets 70, 75 may be free to rotate but fixed spatially (i.e., the first end cannot move vertically or horizontally—only the second ends of the shoulder brackets 70, 75 can move spatially).

Optionally, at least the modules 100 may be detachable, e.g., such that the modules 100 may be removed when not in use and reconnected, as desired. For example, in one embodiment, the joint where the module 100 is coupled to the shoulder bracket 70, 75 may include a connector (not shown) that may be disengaged to allow the module 100 to be selectively removed, while the shoulder bracket 70, 75 remains coupled to the support bracket 60, 65. In this option, if desired, the support bracket 60, 65 may be pivotally mounted to the external structure 50 such that the shoulder bracket 70, 75 may be moved to an inactive position, i.e., out of the way of the user.

In another embodiment, the joint where the shoulder bracket 70, 75 is coupled to the support bracket 60, 65 may include a connector (not shown) that may be disengaged to allow the module 100 and shoulder bracket 70, 75 to be selectively removed, while the support bracket 60, 65 remains coupled to the external structure 50. In this option, if desired, the support bracket 60, 65 may be pivotally mounted to the external structure 50 such that the second end of the shoulder bracket 70, 75 may be moved to an inactive position, i.e., out of the way of the user. When desired, the removed segment(s) may be reconnected to the remaining components to enable use of the module 100 to support the user's arm(s).

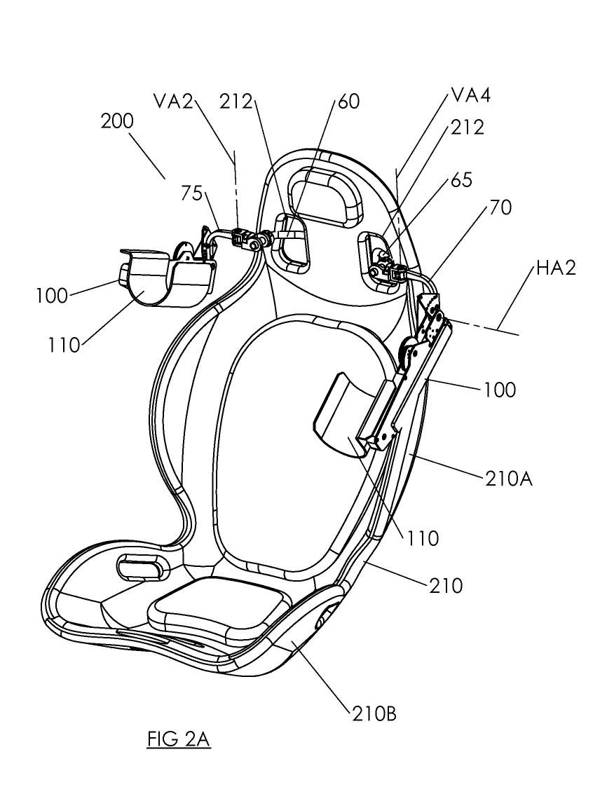

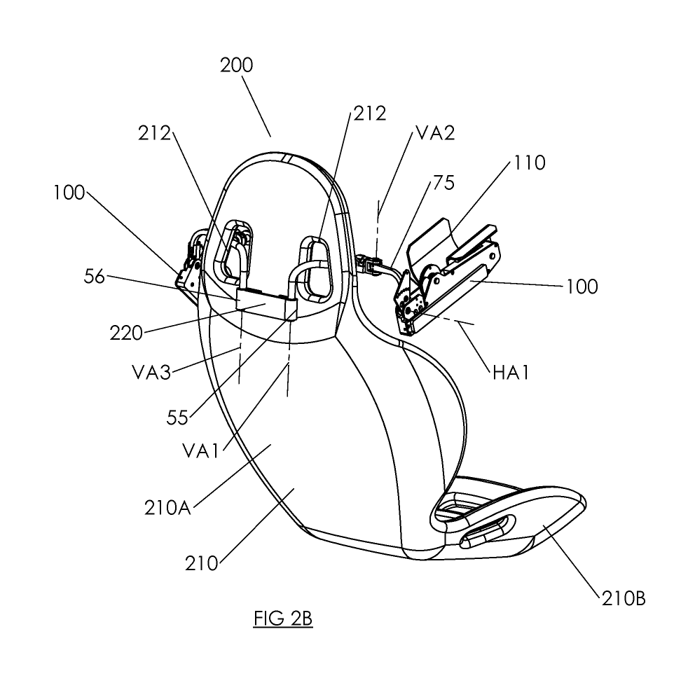

Turning to FIGS. 2A and 2B, another exemplary embodiment of an adaptive arm support system 200 is shown that is mounted in relationship to a seat, for example, an automobile seat 210. Generally, the seat 210 includes one or more cushions or supports, e.g., a seat back 210a and a base 210b, sized and/or shaped to receive the torso of an occupant (not shown). The seat 210 may be mounted within the interior of an automobile or other vehicle (not shown) using conventional structures and methods. As described further below, the system 200 may be mounted to the seat back 210a of the seat 210, although alternatively, the system 200 may be mounted to other structures, e.g., the frame of the vehicle adjacent the seat 210 (not shown).

One or more detachable arm support modules 100 (e.g., one for each arm) may be provided, e.g., similar to the previous embodiment, that carry an armrest 110 shaped and/or sized to receive and support a portion of the user's arm (not shown). The modules 100 may pivot about horizontal axes HA1 and HA2. As previously disclosed in the applications incorporated by reference herein, the modules 100 may provide a counterbalancing force on the user's arm, to offset at least a portion of the weight of the user's arm. Similar to the previous embodiment, each module 100 may include a rigid frame or bracket including a first end mounted to shoulder brackets 70 and 75, which may pivot about vertical axes VA2 and VA4 carried on shoulder tubes 60 and 65, and second free ends. The frame may carry the components of the compensation element(s) and, optionally, a cover (not shown) to prevent exposure of the user to the compensation element(s). Each shoulder bracket 70, 75 is a rigid bar, bracket, or other member, e.g., having a curved “L” shape, that includes a first end coupled to the corresponding seat bracket 60, 65, e.g., such that the shoulder bracket 70, 75 may pivot about vertical axes VA2 and VA4, and a second end coupled to the respective module 100, e.g., to the first end of the frame.

Each seat bracket 60, 65 may be a rigid, tube, bar, or other structure including a first end for mounting the seat bracket 60, 65 to the seat 210, and a second end pivotally coupled to the corresponding shoulder bracket 70, 75. Optionally, the seat brackets 60, 65 may be rotatable about vertical axes VA1 and VA3, for additional mobility, range, or for storage of the adaptive arm support system 200.

For example, as shown in FIG. 2B, the first ends of the seat brackets 60, 65 may be coupled to a support bar or element 220, which may be attached to the seat back 210a of the seat 210, or to another structure (not shown), such as the interior structure of an automobile. In the embodiment shown, the support element 220 is fixedly mounted to the seat back 210a of the seat 210 and the seat back 210a includes an opening 212 between the front and back of the back support 210a through which each seat bracket 60, 65 extends. The first end of the seat brackets 60, 65 may be coupled to the support element 220 at pivot joint 55, 56, which allow the seat brackets 60, 65 to be rotated out of the way after removing the modules 100 and shoulder brackets 70, 75.

For example, the seat brackets 60, 65 and openings 212 may be sized to allow the second ends of the seat brackets 60, 65 to be rotated through the openings 212, e.g., such that the seat brackets 60, 65 are located entirely behind the seat back 210a when not in use. When needed, the seat brackets 60, 65 may be moved back through the openings 212 and the shoulder brackets 70, 75 reconnected to the second ends of the seat brackets 60, 65, thereby allowing the armrests 110 and compensation elements to support the user's arms (or optionally only one arm, if desired). Alternatively, the seat brackets 60, 65 may be retractable to move the second ends against the front of the seat back 210a, optionally, into recesses sized to receive them (not shown), or otherwise to move them to an inactive position that will minimize contact by the occupant of the seat 210 when not in use.

It will be appreciated that elements or components shown with any embodiment herein are merely exemplary for the specific embodiment and may be used on or in combination with other embodiments disclosed herein.

While the invention is susceptible to various modifications, and alternative forms, specific examples thereof have been shown in the drawings and are herein described in detail. It should be understood, however, that the invention is not to be limited to the particular forms or methods disclosed, but to the contrary, the invention is to cover all modifications, equivalents and alternatives falling within the scope of the appended claims.

1. A system for supporting an arm of a user while seated, comprising:
a seat including a base, a seat bracket comprising a first end mounted adjacent the seat and a second end;
an arm support coupled to the second end of the seat bracket configured to support an arm of the user, the arm support configured to accommodate movement of the arm while following the movement without substantially interfering with the movement of the user's arm; and
one or more compensation elements coupled to the arm support to apply an offset force to at least partially offset a gravitational force acting on the arm as the user moves and the arm support follows the movement of the user's arm.

2. The system of claim 1, wherein the seat comprises a seat back including a support element mounted to a rear side of the seat back and an opening extending between the rear side and a front side of the seat back, and wherein the first end of the seat bracket is mounted to the support element such that the second end of the seat bracket extends through the opening to the front side.

3. The system of claim 1, wherein the seat comprises a seat back and wherein the first end of the seat bracket is mounted to the rear side of the seat back such that the second end of the seat bracket extends to the front side of the seat back.

4. The system of claim 2, wherein the arm support comprises:
a first arm support segment pivotally coupled to the second end of the seat bracket such that the first arm support segment such that the first arm support segment is rotatable substantially horizontally about a first vertical axis relative to the second end of the seat bracket; and
a second arm support segment pivotally coupled to the first arm support segment such that the second arm support segment is rotatable vertically about a second horizontal axis.

5. The system of claim 4, further comprising one or more connectors for detachably coupling the first arm support segment to the second end of the seat bracket.

6. The system of claim 4, further comprising one or more connectors for detachably coupling the second arm support segment to the first arm support segment.

7. The system of claim 2, wherein the first end of the seat bracket is fixedly coupled to the support element such that the second end of the seat bracket is fixed relative to the seat back.

8. The system of claim 2, further comprising:
one or more connectors for detachably coupling the arm support to the second end of the seat bracket, and
wherein the first end of the seat bracket is pivotally coupled to the support element such that the second end of the seat bracket is movable relative to the seat back from an active position when the arm support is coupled to the seat bracket and an inactive position when the arm support is detached from the seat bracket.

9. The system of claim 8, wherein the second end of the seat bracket is directed through the opening to the rear side of the seat back in the inactive position.

10. The system of claim 8, wherein the seat back includes a recess in the front side that receives the second end of the seat bracket in the inactive position.

11. (canceled)

12. A system for supporting an arm of a user, comprising:
a mounting structure;
an arm support coupled to the mounting structure configured to support an arm of the user, the arm support configured to accommodate movement of the arm while following the movement without substantially interfering with the movement of the user's arm; and
one or more compensation elements coupled to the arm support to apply an offset force to at least partially offset a gravitational force acting on the arm as the user moves and the arm support follows the movement of the user's arm, the one or more compensation elements providing a force profile that varies the offset force based on an orientation of the arm support.

13. The system of claim 1, wherein the arm support comprises a shoulder bracket pivotally coupled to the mounting structure, and an arm bracket including an arm rest pivotally coupled to the shoulder bracket such that the arm bracket is pivotable about multiple axes relative to the mounting structure.

14. The system of claim 13, wherein the one or more compensation elements comprises one or more elements mounted on the arm bracket.

15. The system of claim 13, wherein the one or more compensation elements comprise a resilient element mounted on the arm bracket.

16. The system of claim 15, wherein the resilient element comprises a spring.

17. The system of claim 12, wherein the arm support comprises:
a first arm support segment pivotally coupled to the mounting structure about a first vertical axis such that the first arm support segment is rotatable substantially horizontally about the first vertical axis relative to the mounting structure; and
a second arm support segment pivotally coupled to the first arm support segment such that the second arm support segment is rotatable about a second axis generally orthogonal to the first vertical axis.

18-23. (canceled)

24. A method for supporting an arm of a user when seated within a vehicle, the vehicle including an arm support mounted within the vehicle adjacent a seat, the method comprising:
sitting in the seat;
placing an arm in an arm rest of the arm support; and
performing one or more tasks involving movement of the arm, the one or more compensation elements applying an offset force to at least partially offset a gravitational force acting on the arm as the user moves without substantially interfering in the movement.

25. The method of claim 24, wherein the one or more tasks comprise driving the vehicle.

26. The method of claim 24, wherein the one or more tasks comprise operating controls adjacent the seat.

27-28. (canceled)

29. The method of claim 24, further comprising moving the arm support to an inactive position so an occupant can sit in the seat without using the arm support.

30. (canceled)
